(19) United States
(12) Patent Application Publication
(10) Pub. No.: US 2007/0205633 A1
(43) Pub. Date: Sep. 6, 2007

(54) ROOF SYSTEM WITH INTEGRATED HVAC DUCTING

(76) Inventors: Douglas L. Waco, Oak Park, IL (US); Mark D. Klassen, Lockport, IL (US); John J. Shmalcs, Lisle, IL (US)

Correspondence Address: CNH AMERICA LLC, INTELLECTUAL PROPERTY LAW DEPARTMENT, PO BOX 1895, MS 641, NEW HOLLAND, PA, 17557, US

(21) Appl. No.: 11/680,167

(22) Filed: Feb. 28, 2007

Related U.S. Application Data
(60) Provisional application No. 60/778,238, filed on Mar. 1, 2006.

(51) Int. Cl. B62D 33/06

(52) U.S. Cl. 296/190.09

(57) ABSTRACT

A molded vehicle cab roof system housing an HVAC unit and having integral ducts for directing air flow from the interior or exterior of the cab, through the HVAC unit and returning conditioned air to the cab interior and the forward windscreen. The roof system comprises first and second molded panels that are fused together to form an integrated assembly.

This application claims the benefit of priority of U.S. Provisional Application 60/778,238, filed Mar. 1, 2006.

### BACKGROUND OF THE INVENTION

The present invention relates to a roof system, more particularly to a roof system with integrated ventilation ducting, and even more particularly to a high-visibility roof system with integrated ventilation ducting for an agricultural vehicle such as, but not limited to, a tractor.

Today', agricultural vehicles with roof-mounted heating ventilation and air conditioning systems (HVAC) are faced with a number of conflicting constraints. A roof support structure is required to protect the operator, seal the cabin environment from outside weather, and provide ample overhead clearance for the operator within the cabin. The roof structure must also house various components of the HVAC system, including the electrical/electronics, blower, heater and evaporator cores, as well as any other cab accessories the designer may desire to position overhead. The roof and support structure must also be compact in nature so that adequate overhead clearance for the vehicle operator is maintained without substantially increasing overall vehicle height.

Furthermore, an airflow system is required to supply air to the ventilation system blower and then distribute air using specifically positioned ducts and vent openings from the HVAC blower into the operator environment. Airflow must be directed to specific locations throughout the cab interior in order to defrost or defog windows and to maintain operator comfort. The roof structure must be aesthetically pleasing offering a colored appearance on the top of the vehicle. The roof structure must also be capable of protecting the cab from outside weather conditions. Today's vehicles typically provide a separate protective roof cap, HVAC unit support structure and air distribution system above the operator cabin. There are additional constraints in today', vehicle, such as operator visibility to the ground, attached implements, and ground environment, the overall height of the vehicle, and styling.

The multitude of functional requirements for an agricultural vehicle roof generally requires a complex roof structure with a significant plurality of individual component parts. Such assemblies are difficult and time consuming to assemble and can be problematic when subjected to the harsh environment typical of an off-road vehicle, In today's competitive market, functional performance using designs that are simple in construction is paramount.

It would be a great advantage to provide a molded vehicle cab roof system suitable for housing an HVAC unit and having integral ducts for receiving air flow from the interior or exterior of the cab, directing airflow through the HVAC unit, and returning conditioned air to optimal locations within the cab interior to overcome the above problems and disadvantages.

### SUMMARY OF THE INVENTION

Accordingly, it is an object of the present invention to provide a roof assembly with integral HVAC ducting that may be easily adapted for use on a wide array of vehicles.

It is another object of the present invention to provide a roof assembly with integral HVAC ducting that is capable of isolating the cab environment from the outside environmental conditions.

It is a further object of the present invention to provide a roof assembly with integral HVAC ducting that provides a protective cap for the vehicle cab.

It is a further object of the present invention to provide a roof assembly that is aesthetically pleasing and colorable for integration with the attached vehicle.

It is a further object of the present invention to provide a roof assembly with integral HVAC ducting that distributes airflow throughout the cab interior and provides defrosting and defogging air flow to the forward windscreen,

It is a still further object of the present invention to provide roof assembly with integral HVAC ducting that allows windows to be positioned in the roof assembly thereby increasing the operator's field of view, especially when overhead implements are used.

It is a still further object of the present invention to provide a roof assembly with integral HVAC ducting that is relatively light in weight.

It is a still further object of the present invention to provide a roof assembly that includes provisions for easily accessing and maintaining installed HVAC components,

It is a still further object of the present invention to provide a roof assembly with integral HVAC ducting that is durable in construction, inexpensive of manufacture, carefree of maintenance, easily assembled, and simple and effective to use.

These and other objects are achieved by providing a molded vehicle cab roof system housing an HVAC unit and having integral ducts for receiving air flow from the interior or exterior of the cab, directing the air flow through the HVAC unit, and returning conditioned air to desired locations within the cab. The roof system comprises first and second molded panels that are fused together to form an integrated assembly.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a perspective view of an agricultural tractor of the type which the present invention is advantageous;

FIG. 2 is a side elevation view of a tractor having a front-mounted implement shown in raised and lowered positions:

FIG. 3 is a partial perspective view of the roof panel of an agricultural tractor showing the preferred embodiment of the present invention; and

FIG. 4 is an exploded perspective view of the roof panel showing the interior air apertures

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right,” “up” or “down,” or “top” or “bottom” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

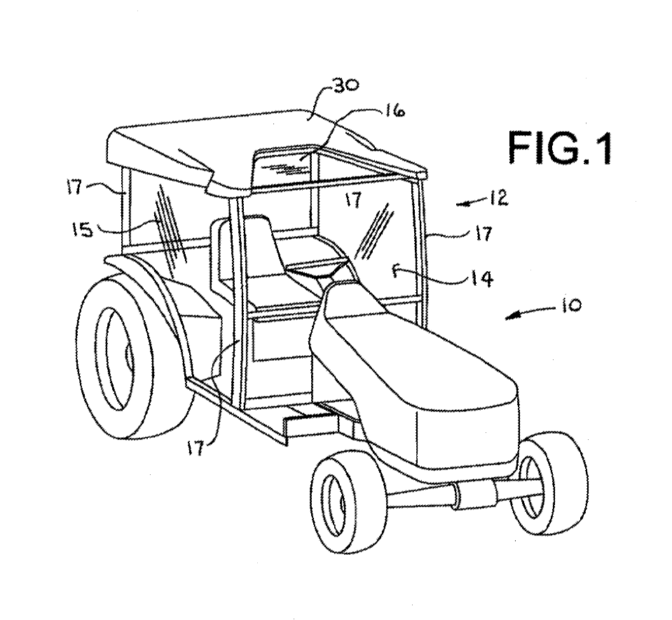

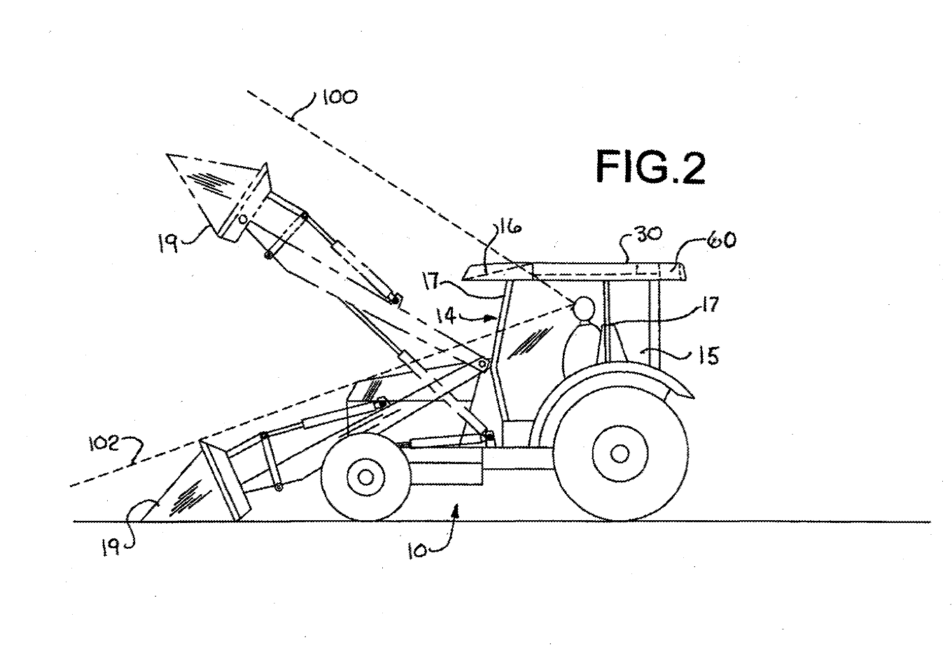

FIG. 1 is a perspective view of an off-road vehicle, a tractor 1o, in this instance, having an enclosed cab 12 covered by roof structure 30 and equipped with an air handling system 20 (shown in FIG. 2). The sides of cab 12 may be opaque walls, translucent windows, or, more commonly, a combination of both, a portion of which may be in the form of doors or windows that can be opened or removed. Roof structure 30 is connected to tractor 10 and supported by a plurality of roll-over protection pillars 17. Roof structure 30 generally extends beyond the sides or ends of the cab walls, forming overhangs which provide additional shade for the operator. As shown, cab 12 has a translucent forward windscreen 14 through which the operator view forward motion of the tractor, side windows 15, and an upwardly directed viewport 16 positioned in the forward portion of the cab roof structure 30 which allows the operator to view front-mounted implements that are lifted, such as front-mounted high-lift buckets and the like.

FIG. 2 illustrates the benefits roof structure 30 of the present invention provides to a tractor 10 having a front-mounted implement 19. When implement 19 is lowered, as when engaging the ground, the operator's lower line of sight 102 is not affected by the roof structure. However, when implement 19 is in an elevated position, as shown in phantom, the operator's sight line 100 would normally be interrupted by a conventional roof structure. The incorporation of upward viewport 16 into the roof structure remedies the limitation by expanding the operator', field of view. Such a modification would normally result in a compromised ventilation system design relative to supplying defrost or defogging airflow to the forward windscreen 14. The present invention overcomes this limitation by providing compact air flow ducts capable of transporting air flow to near the forwardmost portion of the roof with minimal intrusion on the space necessary for the viewport 16.

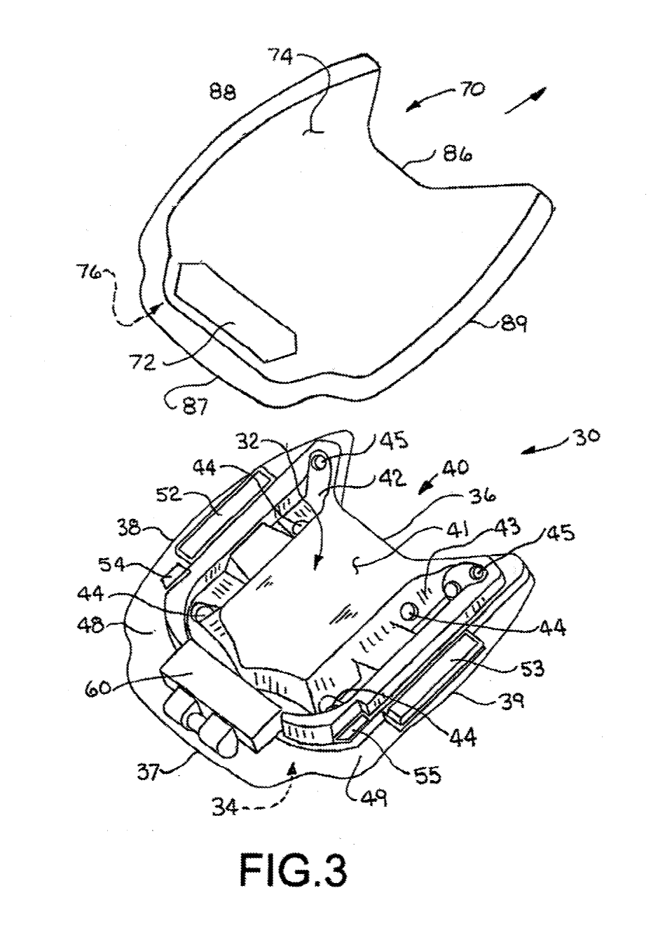

Referring to FIG. 3, an exploded perspective view of roof structure 30 is shown. Roof structure 30 is a cab ventilation airflow system, roof protective structure and cosmetic covering for a vehicle integrated into a single structure. Specifically, the roof structure 30 allows a cab ventilation unit 60, preferably an integrated heating, ventilation, and air conditioning (HVAC) unit, to be housed in the rearward portion of the roof structure to allow room for a trapezoidal window pane 16 (shown in FIG. 1) to be provided along the forward portion of the roof structure 30 thereby improving sight lines for excellent visibility to front-mounted vehicle attachments, such as loader buckets in their up-most position. The roof structure 30 also provides head clearance for the vehicle operator and shade toward the sides and rear of the cab as the roof overhangs the side and rear cab glass. The invention is not limited to this specific type or design of cabin arrangement and can easily be adapted to a broader range of solutions where the ventilation unit 60 is situated in the roof structure.

Roof structure 30 is an integrated composite unit formed from two separately molded, generally planar, contoured panels, inner roof panel 40 and outer roof panel 70, that are joined during assembly. Roof panels 40, 70, while generally planar, are not flat. The panels 40, 70 are shaped to form complimentary portions of air ducts within the roof structure and necessary contours to provide strength for the roof. The result is an integrated roof structure having a thickness greater than the combined thickness of the panels material alone. In the preferred embodiment, roof panels 40, 70 are molded from a high-strength plastic. The inner roof panel 40 comprises a channel side 32, a cab side 34, opposing left and right side ends 38, 39, and forward and rearward ends 36, 37. Cab side 34 is adjacent to the cab interior when the roof structure 30 is installed on tractor 10, though a portion of cab side 34 may overhang the cab interior boundary (side glass) to provide additional shade for the operator. Roof structure overhangs are not necessary to achieve the objectives of the invention, but are included in the preferred embodiment. This arrangement also provides a convenient location for outside air inlet apertures 52, 53, discussed below. Inner roof panel 40 is molded to define a series of indentations on channel side 32 that define the lower portions of air flow ducts, a location for the ventilation unit 60, and locations for any other accessories to be located overhead in the cab. At least one discharge channel 42 is molded into the channel side 32 of inner roof panel forming the lower portion of a discharge duct which, when the inner and outer panels are joined, conveys air flow from ventilation unit 60 to the cab interior. The upper portions of the air flow channels are formed by outer roof panel 70, which when bonded to inner roof panel 40, forms an integrated roof structure 30 with completely functional air intake and return ducts necessary for the cab ventilation system. Additionally, recirculation apertures 54, 55 which allow air to be recirculated within the cab may also be integrated into the roof structure without the need to use cabin pillars or separate headliner pieces.

The roof structure 30 is capable of completely housing the ventilation system 60 and providing intake and discharge ducts and apertures for managing airflow within the cab without relying on the roof support structure or separate filler panels to define the integrated ducting. While a headliner or other similar covering may be used to provide a different appearance on the cab ceiling or for other aesthetic purposes, the headline is not needed for the roof structure to accomplish its functional objectives. Other cab components, such as louvers for the ventilation air discharge apertures 44, 45, the ventilation system control panel, speakers, electrical fuses, and the like may also be connected to or positioned within the roof structure 30. Wires, hoses, cables, and the like necessary to operate components or accessories positioned in the roof structure are routed to the roof structure along or within one or more of the roll-over protection pillars 17.

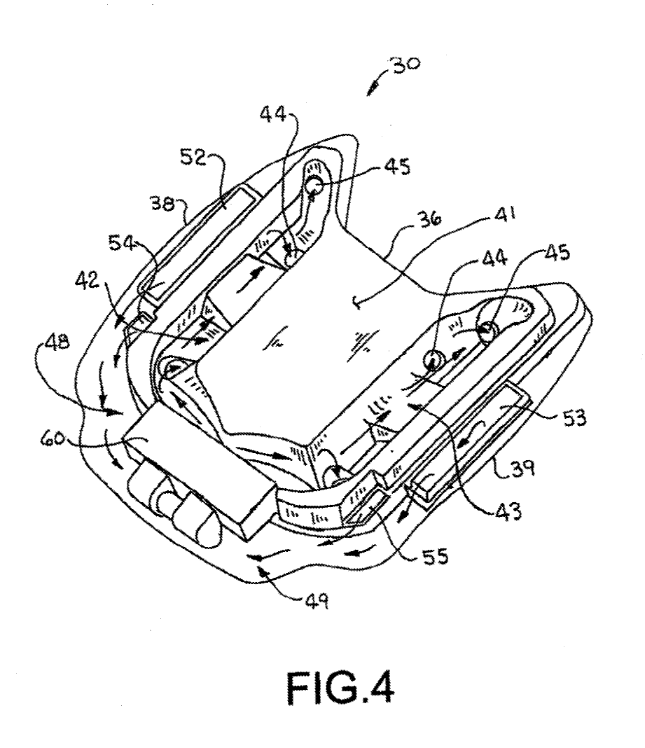

Referring now to FIGS. 3 and 4, a pair of discharge channels 42, 43 receive air flow from the ventilation unit 60 and convey the air flow to the cab via a plurality of discharge apertures 44, 45. In the preferred embodiment, discharge conduits 42, 43 are positioned generally along the left and right side ends 38, 39 of the panel leaving a central portion 41 of the inner roof panel 40 raised with respect to the cab to provide maximum headroom in the cab for the operator. Discharge apertures 44 are positioned so that air flow from conduits 42, 43 is directed to desired locations within the cab interior. In the preferred embodiment, forward apertures 45 are also provided to direct a portion of the air flow from discharge conduits 42, 43 toward the forward windscreen 14 for defrosting and defogging of the forward window (windscreen).

Inner roof panel 40 also comprises at least one air intake conduit 48 to convey air flow from either the cab interior (e.g., recirculation flow) or from outside of the cab (e.g., fresh air intake) to the ventilation unit 60. In the preferred embodiment, a pair of intake conduits 48, 49 are employed, each generally paralleling the respective discharge conduits 42, 43. Air enters intake conduits 48, 49 through either outside air inlet apertures 52, 53 or from cab air inlets 54, 55, depending on the ventilation control mode selected by the operator. Operator selection of intake air source is typically controlled from a cab-located control panel and is generally accomplished by dampers situated proximate to the intake apertures. Outside air entering through outside air inlet apertures 52, 53 is preferably filtered as it enters the intake conduits 48, 49 to reduce the amount of contaminants, such as dust, pollen, chaff and the like, entering the cab environment. Cab air recirculation may be selected when the concentration of outside airborne contaminants is greater than fresh air intake filters can effectively accommodate, Recirculation air entering the intake conduits 48, 49 may or may not be filtered.

The outer roof panel 70 is shaped to fit cooperatively with inner roof panel 40 and complete the portions of the intake and discharge conduits not molded into inner roof panel 40. Similar to inner panel 40, outer panel 70 has opposing forward and rearward ends 86, 87, and orthogonally oriented opposing left and right side edges 88, 89 generally defining the perimeter of the outer panel. Outer roof panel 70 is molded from colorable, high-strength plastic to aesthetically integrate with the overall appearance of the vehicle. The outer roof panel 70 also provides a weather-resistance top cover for the vehicle cab and the components housed within the interior of the roof structure. Outer roof panel 70 is permanently bonded to inner roof panel 40 during initial assembly to for a unitary roof structure 30. Bonding may be by adhesive, fusion method, or other functionally equivalent method. An access panel 72 is provided to allow access to the HVAC system 60 for installation, maintenance, or replacement.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions.

Having thus described the invention, what is claimed is:

1. A roof system having integrated HVAC ducting for a vehicle cab comprising:
a generally planar first panel having a cab side and a generally opposing and coextensive channel side, said first panel shaped to define the lower portion of at least one elongate air intake duct, the lower portion of at least one elongate air discharge duct, and a ventilation unit support structure, said at least one air intake duct having at least one fresh air aperture through said first panel for selectively receiving air from the exterior of said vehicle cab, at least one recirculation air aperture through said first panel for selectively receiving air from the interior portion of said vehicle cab, and at least one air discharge aperture through said first panel for passing air from said at least one air discharge duct to the interior portion of said vehicle cab;
a generally planar second panel having an exterior side and a generally opposing and coextensive channel mating side, said second panel connected to said first panel thereby forming an integrated roof panel, said channel mating side shaped to interact with said first panel, and, when connected to said first panel, enclose said at least one air intake duct and said at least one air discharge duct whereby air flow between said intake and discharge ducts is limited to predefined locations, said integrated roof panel having opposing forward and rearward ends and opposing left and right side ends, said forward and rearward ends and said left and right side ends surrounding a central roof portion; and
a cab ventilation unit connected to said first panel, said ventilation unit receiving air from said at least one intake duct and delivering air to said at least one discharge duct.

2. The roof system of claim 1, wherein said air intake and discharge ducts are positioned adjacent said rearward end and said left or right side ends and the cab side of said central roof portion is elevated with respect to the vehicle cab for clearance.

3. The roof system of claim 1, further comprising at least one defrost air aperture through said first panel and positioned adjacent the forward end of said first panel whereby air flow from said defrost air aperture is generally directed toward a forward portion of said cab.

4. The roof system of claim 1, further comprising a location for HVAC controls.

5. The roof system of claim 1, further comprising left and right air intake air ducts, left and right discharge air ducts, said left air intake and said left air discharge ducts being generally parallel and directed adjacent said left side end, said right air intake and said right air discharge ducts being generally parallel directed adjacent said left side end.

6. The roof system of claim 5, further comprising at least one defrost air aperture through said first panel positioned adjacent the forward end of said first panel whereby air flow from said defrost air aperture is directed toward a forward portion of said cab.

7. A roof structure for an off-road vehicle comprising:
a vehicle having generally opposing forward and rearward ends;
an operator's platform;
a cab enclosing said operator's platform, said cab enclosure having a forward facing windscreen and at least one support pillar, and
a roof structure connected to said at least one support pillar and covering said cab, said roof structure further comprising;
a generally planar first panel having a cab side and a generally opposing and coextensive channel side, said first panel shaped to define the lower portion of at least one elongate air intake duct, the lower portion of at least one elongate air discharge duct, and a ventilation unit support structure, said at least one air intake duct having at least one fresh air aperture through said first panel for selectively receiving air from the exterior of said vehicle cab, at least one recirculation air aperture through said first panel for selectively receiving air from the interior portion of said vehicle cab, and at least one air discharge aperture through said first panel for passing air from said at least one air discharge duct to the interior portion of said vehicle cab;
a generally planar second panel having an exterior side and a generally opposing and coextensive channel mating side, said second panel connected to said first panel thereby forming an integrated roof panel, said channel mating side shaped to interact with said first panel, and, when connected to said first panel, enclose said at least one air intake duct and said at least one air discharge duct whereby air flow between said intake and discharge ducts is limited to predefined locations, said integrated roof panel having opposing forward and rearward ends and opposing left and right side ends, said forward and rearward ends and said left and right side ends surrounding a central roof portion; and
a cab ventilation unit connected to said first panel, said ventilation unit receiving air from said at least one intake duct and delivering air to said at least one discharge duct.

8. The roof structure of claim 7, wherein said air intake and discharge ducts are positioned adjacent said rearward end and said left or night side ends and the cab side of said central roof portion is elevated with respect to the vehicle cab for clearance.

9. The roof structure of claim 8, further comprising at least one defrost air aperture through said first panel and positioned adjacent the forward end of said first panel whereby air flow from said defrost air aperture is directed to flow toward and generally parallel to said windscreen.

10. The roof structure of claim 9, further comprising left and right air intake air ducts, left and right discharge air ducts, said left air intake and said left air discharge ducts being generally parallel and directed adjacent said left side end, said right air intake and said right air discharge ducts being generally parallel directed adjacent said left side end.

11. The roof structure of claim 10, wherein each said discharge duct comprises at least one defrost air aperture through said first panel and positioned adjacent the forward end of said first panel whereby air flow from said defrost air aperture is directed to flow toward and generally parallel to said windscreen.

12. The roof structure of claim 11, further comprising a viewport connected to said roof structure and positioned adjacent to said forward end of said roof structure.

13. The roof structure of claim 12, wherein said off-road vehicle further comprises a front-mounted implement movable in upward and downward directions wherein said viewport enables an operator to view said implement when in extreme upward positions.
